(19) United States
(12) Patent Application Publication
(10) Pub. No.: US 2026/0061775 A1
(43) Pub. Date: Mar. 5, 2026

(54) TIRE INFLATION CAGE SYSTEM

(71) Applicant: Tom Miller, Waterloo, IN (US)

(72) Inventor: Tom Miller, Waterloo, IN (US)

(21) Appl. No.: 18/819,072

(22) Filed: Aug. 29, 2024

(51) Int. Cl. B60B 30/02

(52) U.S. Cl. CPC B60B 30/02

(57) ABSTRACT

A tire inflation safety cage system includes: an air conveyor device; and a tire inflation safety cage assembly selectively operatively coupled with the air conveyor device, the tire inflation safety cage assembly including: a frame, including at least one hollow tube which is configured for at least partly surrounding a wheel assembly; and at least one valve coupled with the frame and thereby being configured for transmitting pressurized air out of the at least one hollow tube, the at least one hollow tube being configured for storing the pressurized air therein.

### BACKGROUND OF THE INVENTION

### 1. Field of the Invention The present invention relates to tire inflation systems, and, more particularly, to tire inflation safety cages.

### 2. Description of the Related Art

Tire inflation safety cages are used to house a wheel assembly therein during inflation of a tire under relatively high pressure. Tires can explode during inflation, and such safety cages can protect persons and property within the vicinity of the tire during inflation. A known tire inflation safety cage includes a base and a plurality of arched bars connected to the base. The wheel assembly to be inflated is positioned on the base and at least partially within a space defined by the base and the arched bars, which shield persons and property positioned nearby during inflation of the tire.

A wheel assembly (such as a wheel of an automobile) typically includes a wheel and a tire which is inflated and is seated on the wheel. More specifically, the wheel includes a rim, and the tire includes a bead which forms a seal with the rim when the tire is properly inflated and seated on the wheel.

An air blast bead seater is often used to seat the bead of a tire on the rim of a wheel. The air blast bead seater emits a high pressurized blast of air so as to seat the bead on the rim. The air blast bead seater can include an air storage tank which stores the pressurized air therein.

What is needed in the art is a tire inflation safety cage which can work in conjunction with an air blast bead seater.

### SUMMARY OF THE INVENTION

The present invention provides a tire inflation safety cage system including a tire inflation safety cage assembly including a frame with a hollow tube and a valve coupled with the frame, the hollow tube being configured for storing pressurized air therein.

The invention in one form is directed to a tire inflation safety cage system which includes: an air conveyor device; and a tire inflation safety cage assembly selectively operatively coupled with the air conveyor device, the tire inflation safety cage assembly including: a frame, including at least one hollow tube which is configured for at least partly surrounding a wheel assembly; and at least one valve coupled with the frame and thereby being configured for transmitting pressurized air out of the at least one hollow tube, the at least one hollow tube being configured for storing the pressurized air therein.

The invention in another form is directed to a tire inflation safety cage assembly of a tire inflation safety cage system, the tire inflation safety cage system including an air conveyor device, the tire inflation safety cage assembly being selectively operatively coupled with the air conveyor device, the tire inflation safety cage assembly including: a frame, including at least one hollow tube which is configured for at least partly surrounding a wheel assembly; and at least one valve coupled with the frame and thereby being configured for transmitting pressurized air out of the at least one hollow tube, the at least one hollow tube being configured for storing the pressurized air therein.

The invention in another form is directed to a method of using a tire inflation safety cage system, the method including the steps of: providing that the tire inflation safety cage system includes an air conveyor device and a tire inflation safety cage assembly, the tire inflation safety cage assembly including a frame and at least one valve, the frame including at least one hollow tube, the at least one valve being coupled with the frame; selectively operatively coupling the tire inflation safety cage assembly with the air conveyor device; storing pressurized air in the at least one hollow tube; surrounding, by way of the at least one hollow tube, at least partly a wheel assembly; and transmitting, by way of the at least one valve, the pressurized air out of the at least one hollow tube.

An advantage of the present invention is that it includes a tire inflation safety cage configured for storing pressurized air therein.

Another advantage is that the tire inflation safety cage provides the storage mechanism for storing pressurized air, which can be used by an air blast bead seater device.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematically view of a tire inflation safety cage system, which includes an air conveyor device, a tire inflation safety cage assembly, and an air blast bead seater device, in accordance with an exemplary embodiment of the present invention;

FIG. 2 is a perspective view (partially schematic) of an embodiment of the tire inflation safety cage system, which includes the tire inflation safety cage assembly, in accordance with an exemplary embodiment of the present invention;

FIG. 3 is a perspective view (partially schematic) of another embodiment of the tire inflation safety cage system, which includes the tire inflation safety cage assembly, in accordance with an exemplary embodiment of the present invention;

FIG. 4 is a perspective view (partially schematic) of yet another embodiment of the tire inflation safety cage system, which includes the tire inflation safety cage assembly, in accordance with an exemplary embodiment of the present invention; and

FIG. 5 is a flow diagram showing a method of using a tire inflation safety cage system, in accordance with an exemplary embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

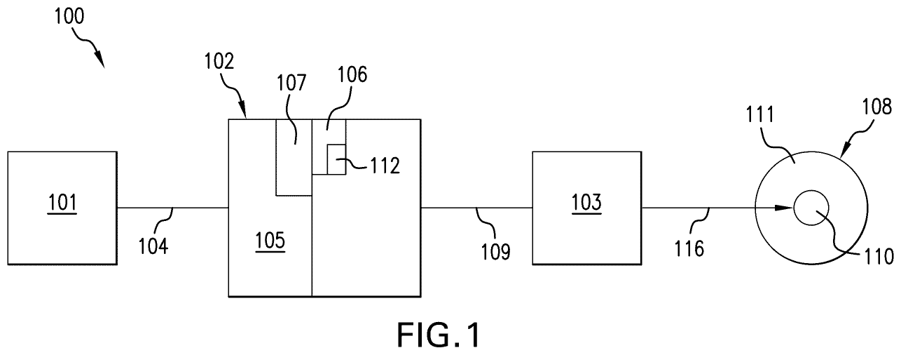

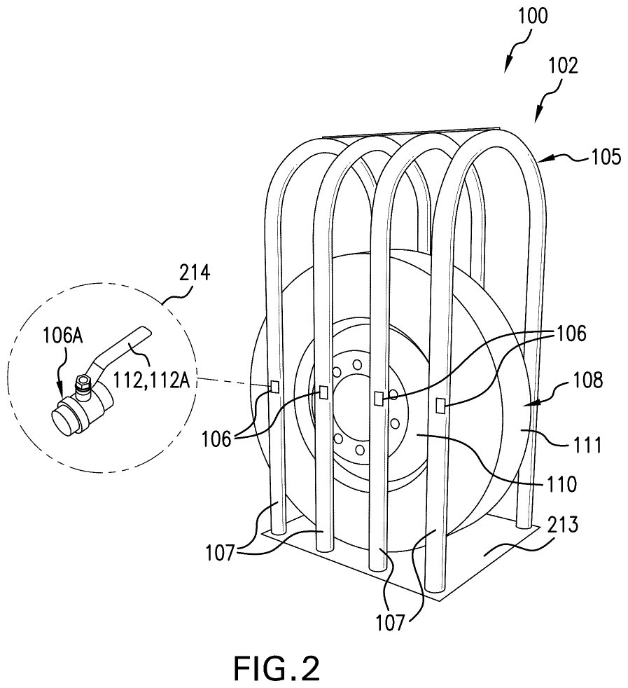

Referring now to the drawings, and more particularly to FIG. 1, there is shown schematically a tire inflation safety cage system 100 according to the present invention (FIG. 1 is a general, schematic view of cage system 100 and thus intended to cover more specific embodiments of cage system 100, as shown in FIGS. 2, 3, and 4, and any other embodiments disclosed herein). Tire inflation safety cage system 100 generally includes an air conveyor device 101 (which can also be referred to herein as air conveyor 101), a tire inflation safety cage assembly 102 (which can also be referred to herein as cage assembly 102), an air blast bead seater device 103 (which can also be referred to herein as bead seater 103), and at least one air conduit 104 (such as air hose 104). Air conveyor device 101 is any device configured for conveying air to cage assembly 102, for example (and not limitation), an air pump or an air compressor; air conveyor 101 may be disconnected from cage assembly 102 when pressurized air is stored in cage assembly 102. According to the present invention, air conveyor 101 is selectively operatively coupled (in any suitable manner) with cage assembly 102, such that air conveyor 101 (when operatively coupled with cage assembly 102) is configured for conveying and thereby for communicating pressurized air to cage assembly 102 (more particularly, to at least one hollow tube 107 (which can also be referred to as a pipe 107) of cage assembly 102, FIG. 2), so that the pressurized air can be stored in cage assembly 102 and eventually conveyed to bead seater 103 and onward outside of bead seater 103 to a wheel assembly 108. Further, air conveyor 101 is configured for being selectively operatively decoupled from cage assembly 102, such that air conveyor 101 and cage assembly 102 are no longer in fluid communication with one another. At least one air conduit 104 enables air conveyor 101 and cage assembly 102 to be operatively coupled with one another and thus also in fluid communication with one another. Thus, air conduit 104 is configured for transmitting the pressurized air from air conveyor device 101 to at least one hollow tube 107.

Cage assembly 102 includes a frame 105 and at least one valve 106. Frame 105 includes at least one hollow tube 107 (which can be referred to herein as tube 107), for example (and not limitation), a plurality of tubes 107 (see FIG. 2), for example (and not limitation) four tubes 107 (it can readily be appreciated that cage assembly may include any suitable number of tubes 107). Tube 107 can have any suitable cross-section, for example (and not limitation) a round or square cross-section (herein, it is assumed that the cross-section of tube 107 is round). Tube 107 is configured for at least partly surrounding a wheel assembly 108 (see FIG. 2), wherein wheel assembly 108 includes a wheel 110 and a tire 111 that couples with wheel 110. Valve 106 is coupled with frame 105, such as tube 107, and thereby is configured for transmitting pressurized air (i) from air conveyor 101 into at least one hollow tube 107, and/or (ii) out of at least one hollow tube 107. Tube 107 is configured for storing the pressurized air therein, even when air conveyor 107 is operatively decoupled from tube 107.

Bead seater 103 is operatively coupled (in any suitable manner) with valve 106 and is configured for fluidly communicating with tube 107. Bead seater 103 is configured (in any suitable manner) for emitting a blast 116 of the pressurized air from tube 107 towards wheel assembly 108 so as to seat the tire 111 of wheel assembly 108 onto wheel 110 of wheel assembly 108. Optionally, cage system 100 further includes at least one air conduit 105 (such as air hose 105) configured for transmitting the pressurized air from tube 107 to bead seater 103 by way of valve 106, such that tube 107 and bead seater 103 are fluidly coupled with one another by way of valve 106). Alternatively, conduit 105 may be omitted, and tube 107 may be directly fluidly coupled with bead seater 103 by way of valve 106.

Valve 106 includes an actuator 112 configured for enabling the pressurized air to flow through the at least one valve 106. Valve 106 can be activated in any suitable manner, such as electrically, pneumatically (by air), or mechanically, and in this way, actuator 112 is an electrical actuator (and thus, valve 106 can be, for example, a solenoid valve), a pneumatic actuator, or a mechanical actuator. If valve is activated mechanically, then mechanical actuator 112 can be, for example (and not limitation), a lever 112, wherein lever 112 is moved (i.e., turned) in any suitable manner, such as by way of a linear tether, for example (and not limitation) a rope, string, wire, or the like; that is, a user of system 100 may be positioned a safe distance away from wheel assembly 108 and pull on the linear tether so as to turn lever 112, which then opens valve 106 so as to allow air within tube 107 to be released to bead seater 103 so that a blast 116 of air from bead seater 103 seats a bead of tire 111 on a rim of wheel 110. Thus, any suitable valve 106 can be used as a part of the present invention, and thus, for example (and not limitation), valve 106 can be actuated in any suitable manner, such as by hand (manually), electrically, or by air. Further, valves 106 can be located on any part of, and at any suitable location of, cage assembly 102.

Further, in accordance with the present invention, bead seater 103 lacks (has an absence of) an air storage tank. Instead, tube(s) 107 serves as an air storage tank for bead seater 103 (thus, within the present disclosure, tube 107 is a different device than bead seater 103) and thereby provides air to bead seater 103 for the blast 116 of air that is directed at wheel assembly 108 when seating the bead of tire 111 on the rim of wheel 110. In summary, in accordance with the present invention, valves 106 are added to tubes 107 so as to use tubes 107 of cage assembly 102 as a storage tank, thereby eliminating the need for an external tank to seat the beads of tire 111, thereby allowing the user of cage assembly 102 and bead seater 103 to be further away from tire 111 during the seating of the beads using bead seater 103.

Referring now to FIG. 2, there is shown a perspective view (partially schematic) of cage system 100, in accordance with a first embodiment of the present invention. Cage system 100 is shown to include tire inflation safety cage assembly 102, which includes frame 105 and a plurality of valves 106, and frame 105 is shown to include a base 213 to which hollow tubes 107 are mounted. Four arched tubes 107 are shown in FIG. 2 (it is understood that any suitable number of tubes 107 can be used). Wheel assembly 108 is positioned on base 213 and under tubes 107. According to this embodiment of the present invention, a single valve 106 is coupled (in any suitable manner) with a single respective tube 107. Each valve 106 is shown schematically on a respective tube 107 by way of a small square; though the small square is shown on the lateral outside of a respective tube 106, valve 106 can be placed on tube 107 at any suitable location. FIG. 2 also shows an enlarged detail view 214 of one embodiment of valve 106, which is labeled as valve 106A in detail view 214. Valve 106A is a mechanically actuated valve with a lever 112A as the actuator 112, wherein lever 112A can be rotated so as to open and/or close valve 106A (lever 112A can be rotated using any suitable way, as described above). As indicated above, however, valve 106 can optionally be a different type of valve, such as an electrically actuated valve or a pneumatically actuated valve. Though each tube 107 is shown to have a valve 106 attached therewith, it can be appreciated that only one such tube 107 may have valve 106 coupled therewith. An advantage of having a valve 106 attached to each tube 107, however, is that more pressurized air storage space is provided; that is, a valve 106 on each tube 107 enables each tube 107 to store pressurized air. Though not shown, it can be appreciated that one or more tubes 107 can have coupled therewith a pressure gauge so as to sense the pressure of the pressurized air stored in the respective tube 107.

Further, in use of cage system 100 shown in FIG. 2, a user can couple—in any suitable manner (for example (and not limitation) by way of air conduit 104)—air conveyor device 101 with a respective valve 106 and thereby input pressurized air into the respective tube 107; this can be done for each of tubes 107 with a respective valve 106. After detaching air conveyor device 101 from the respective valve, pressurized air is stored in the respective tube 107 until that pressurized air is needed for an air blast 116 to seat tire 111 on wheel 110. When this is needed, a user can couple—in any suitable manner (for example (and not limitation) by way of air conduit 109)—bead seater 103 with valve 106, and pressurized air can be output from tube 107 through bead seater 103 upon actuating bead seater 103 and/or valve 106 so as to provide a blast 116 of air in order to seat the bead of tire 111 on wheel 110.

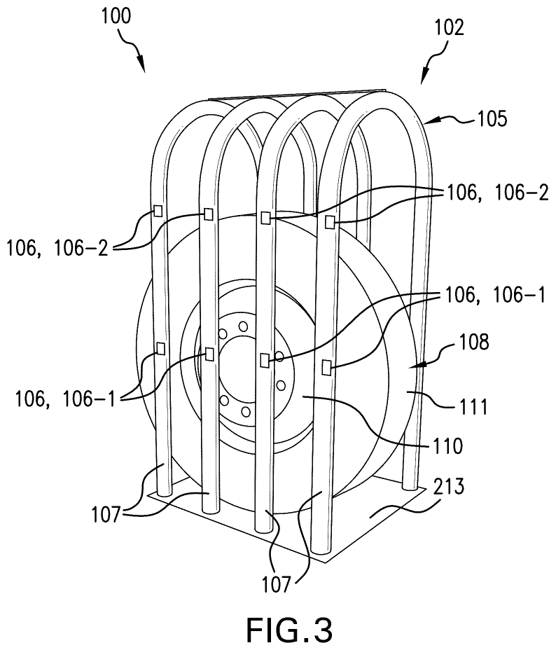

Referring now to FIG. 3, there is shown a perspective view (partially schematic) of cage system 100, in accordance with another embodiment of the present invention. Cage system 100 is shown to include tire inflation safety cage assembly 102, which includes frame 105 and a plurality of valves 106, and frame 105 is shown to include base 213 to which hollow tubes 107 are mounted. Four arched tubes 107 are shown in FIG. 2 (it is understood that any suitable number of tubes 107 can be used). Wheel assembly 108 is positioned on base 213 and under tubes 107. According to this embodiment of the present invention, each tube 107 (alternatively, each tube 107 that includes a valve 106) includes two valves 106 (which can be similar to or different from valve 106A), rather than a single valve 106, each valve 106 being coupled (in any suitable manner) with a respective tube 107. Each valve 106, as in FIG. 2, is shown schematically on a respective tube 107 by way of a small square; valves 106 can be placed on tube 107 at any suitable location. Though each tube 107 is shown to have two valves 106 attached therewith, it can be appreciated that only one such tube may have valves 106 coupled therewith. An advantage of having at least one valve 106 attached to each tube 107, however, is that more pressurized air storage space is provided. Though not shown, it can be appreciated that one or more tubes 107 can have coupled therewith a pressure gauge so as to sense the pressure of the pressurized air stored in the respective tube 107. A reason for two valves 106 per tube 107 (rather than one valve 106 per tube 107) is that one valve 106 (i.e., valve 106-1) can be used for input pressurized air into tube 107 (that is, inputting pressurized air by way of air conveyor 101) and that the other valve 106 (i.e., valve 106-2) can be used for output pressurized air exiting tube 107 and thus also exiting bead seater 103.

Further, in use of cage system 100 shown in FIG. 3, a user can couple—in any suitable manner (for example (and not limitation) by way of air conduit 104)—air conveyor device 101 with a respective valve 106 (i.e., valve 106-1) of a respective tube 107 and thereby input pressurized air into the respective tube 107; this can be done for each of tubes 107 with a respective valve 106 (i.e., valve 106-1). Further, upon desiring to use bead seater 103 in conjunction with cage assembly 102, bead seater 103 can be coupled (in any suitable manner) with the other of the valves 106 (i.e., valve 106-2) of the respective tube 107. A user can use bead seater 103 to issue a blast 116 of air from the respective tube 107 so as to seat the bead of tire 11 on wheel 110.

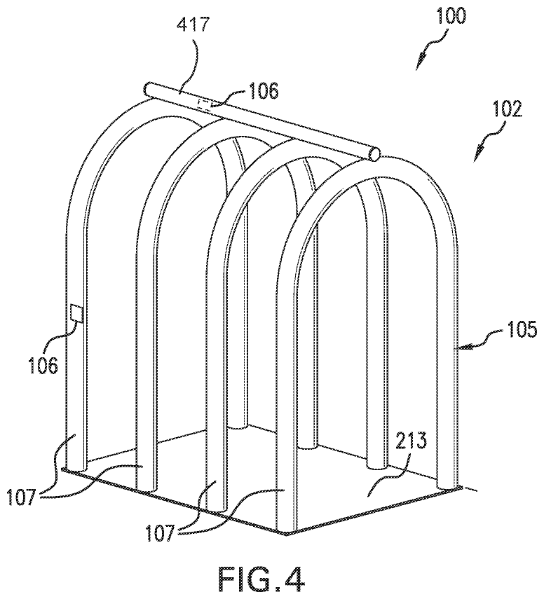

Referring now to FIG. 4, there is shown a perspective view (partially schematic) of cage system 100, in accordance with another embodiment of the present invention. Cage system 100 is shown to include tire inflation safety cage assembly 102, which includes frame 105 and at least one valve 106, and frame 105 is shown to include base 213 to which hollow tubes 107 are mounted. Four arched tubes 107 are shown in FIG. 2 (it is understood that any suitable number of tubes 107 can be used). Wheel assembly 108 (not shown in FIG. 4) can be positioned on base 213 and under tubes 107. According to this embodiment of the present invention, frame 105 further includes a hollow joining tube 417 (which can also be referred to as a pipe 417) positioned at or near a top of arched tubes 107. FIGS. 2 and 3 show that tubes 107 are joined by an elongate bar positioned at or near the top of arched tubes 107; this elongate bar provides stability to arched tubes 107 and structural integrity to frame 105. However, this elongate bar is not hollow and thus cannot store pressurized air therein or otherwise fluidically communicate with respective interiors of tubes 107. By contrast, hollow joining tube 417 is configured for staring pressurized air therein and includes openings (not shown) that enable a hollow interior of joining tube 417 to communicate with each of the interiors of tubes 107. In this way, each of tubes 107 (that is, the respective interiors of each tube 107) and joining tube 417 (that is, the interior of joining tube 417) are in fluid communication with each other, such that pressurized air can flow between each of tubes 107, 417 and can be stored in each of tubes 107, 417. Further, by way of this arrangement, a single valve 106 can be coupled (directly or indirectly) with one of the arched tubes 107 or joining tube 417 so as to insert pressurized air into each of tubes 107, 417 thereby (using air conveyor device 103), and thereby to store pressurized air in each of tubes 107, 417, and to withdraw pressurized air from each of tubes 107, 417, such as for an air blast using bead seater 103. Merely by way of example and not limitation, one valve 106 is shown (using a small square) in solid lines coupled with tube 107, and one valve 106 is shown in broken lines (so as to show an alternative position for the single valve 106) coupled with tube 417. Alternatively, a plurality of valves can be coupled with tubes 107 and/or 417 for air insertion purposes (using air conveyor device 102) and/or air extraction purposes (using bead seater 103). Though joining tube 417 is shown above (but in contact with) the top center of arched tubes 107 in FIG. 4, joining tube 417 (or any other similar joining tube) can be positioned at any suitable location of arched tubes 107. For example, instead of above the top center of arched tubes 107, joining tube 417 can be positioned (not shown): (a) below (but in contact with) the top center of arched tubes 107 and thus extending (as in FIG. 3) from one arched tube 107 to the other; (b) at the bottom of arched tubes 107 and thus extending (as in FIG. 3) from one arched tube 107 to the other, more specifically, at or near base 213 and to the inside or outside of the bottom of respective legs of arched tubes 107 (for example, the left side legs (shown in the foreground of FIG. 3) or the right side legs (shown in the background of FIG. 3) of tubes 107); or (c) at an intermediate position between the top center of arched tubes 107 and the bottom of arched tubes and thus extending (as in FIG. 3) from one arched tube 107 to the other (whether to the left side legs or the right side legs of the tubes 107).

Further, in use of cage system 100 shown in FIG. 4, a user can couple—in any suitable manner (for example (and not limitation) by way of air conduit 104)—air conveyor device 101 with a respective valve 106 of a respective tube 107 or 417 and thereby input pressurized air into the tubes 107, 417, given that each of tubes 107, 417 fluidically communicate with one another. Further, upon desiring to use bead seater 103 in conjunction with cage assembly 102, bead seater 103 can be coupled (in any suitable manner) with any suitable valve 106. A user can use bead seater 103 to issue a blast 116 of air from tubes 107, 417 so as to seat the bead of tire 11 on wheel 110.

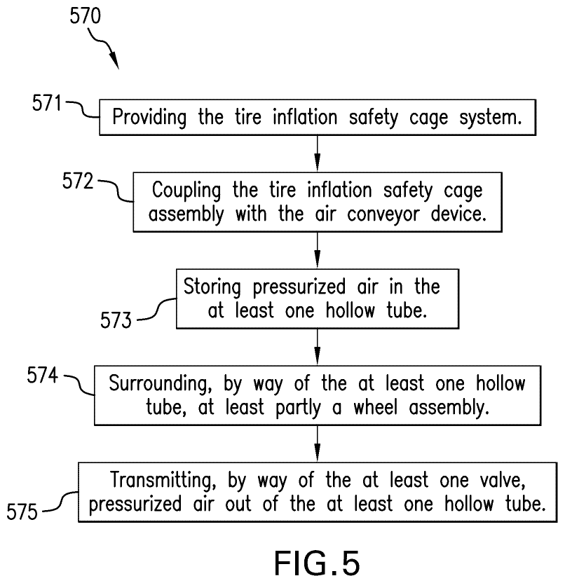

Referring now to FIG. 5, there is shown a flow diagram of a method 570 of using a tire inflation safety cage system 100. Method 570 includes the steps of: providing 571 that the tire inflation safety cage system 100 includes an air conveyor device 101 and a tire inflation safety cage assembly 102, the tire inflation safety cage assembly 102 including a frame 105 and at least one valve 106, the frame 105 including at least one hollow tube 107, the at least one valve 106 being coupled with the frame 105; selectively operatively coupling 572 the tire inflation safety cage assembly 102 with the air conveyor device 101; storing 573 pressurized air in the at least one hollow tube 107; surrounding 574, by way of the at least one hollow tube 107, at least partly a wheel assembly 108; and transmitting 575, by way of the at least one valve 106, the pressurized air out of the at least one hollow tube 107. The tire inflation safety cage system 100 can further include an air blast bead seater device 103 operatively coupled with the at least one valve 106 and configured for fluidly communicating with the at least one hollow tube 107. The air blast bead seater device 103 can be configured for emitting a blast 116 of the pressurized air from the at least one hollow tube 107 towards the wheel assembly 108 so as to seat a tire 111 of the wheel assembly 108 onto a wheel 110 of the wheel assembly 108. The at least one valve 106 can include an actuator 112 configured for enabling the pressurized air to flow therethrough. The tire inflation safety cage system 100 can further include at least one air conduit 104, 109 configured for transmitting the pressurized air from the air conveyor device 101 to the at least one hollow tube 107 or from the at least one hollow tube 107 to the air blast bead seater device 103. The air blast bead seater device 103 has an absence of an air storage tank, wherein: (i) the at least one valve is coupled with the at least one hollow tube; or (ii) the frame includes a hollow joining tube in fluid communication with the at least one hollow tube, the at least one valve being coupled with the hollow joining tube.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A tire inflation safety cage system, comprising:
an air conveyor device; and
a tire inflation safety cage assembly selectively operatively coupled with the air conveyor device, the tire inflation safety cage assembly including:
a frame, including at least one hollow tube which is configured for at least partly surrounding a wheel assembly, and
at least one valve coupled with the frame and thereby being configured for transmitting pressurized air out of the at least one hollow tube, the at least one hollow tube being configured for storing the pressurized air therein; and
a base, the at least one hollow tube being an upstanding arched pipe that includes a first terminating end attached to the base, a second terminating end attached to the base and opposing the first terminating end, and an upstanding arched section being positioned and extending between the first terminating end and the second terminating end.

2. The tire inflation safety cage system according to claim 1, further including an air blast bead seater device operatively coupled with the at least one valve and configured for fluidly communicating with the at least one hollow tube, wherein the at least one valve is configured for transmitting the pressurized air from the air conveyor device into the at least one hollow tube.

3. The tire inflation safety cage system according to claim 2, wherein the air blast bead seater device is configured for emitting a blast of the pressurized air from the at least one hollow tube towards the wheel assembly so as to seat a tire of the wheel assembly onto a wheel of the wheel assembly.

4. The tire inflation safety cage system according to claim 3, wherein the at least one valve includes an actuator configured for enabling the pressurized air to flow therethrough.

5. The tire inflation safety cage system according to claim 4, further comprising at least one air conduit configured for transmitting the pressurized air from the air conveyor device to the at least one hollow tube or from the at least one hollow tube to the air blast bead seater device.

6. The tire inflation safety cage system according to claim 5, wherein the air blast bead seater device has an absence of an air storage tank, and wherein the at least one valve is fluidly coupled with the at least one hollow tube.

7. A tire inflation safety cage assembly of a tire inflation safety cage system, the tire inflation safety cage system including an air conveyor device, the tire inflation safety cage assembly being selectively operatively coupled with the air conveyor device, the tire inflation safety cage assembly comprising:
a frame, including at least one hollow tube which is configured for at least partly surrounding a wheel assembly, and
at least one valve coupled with the frame and thereby being configured for transmitting pressurized air out of the at least one hollow tube, the at least one hollow tube being configured for storing the pressurized air therein; and
a base, the at least one hollow tube being an upstanding arched pipe that includes a first terminating end attached to the base, a second terminating end attached to the base and opposing the first terminating end, and an upstanding arched section being positioned and extending between the first terminating end and the second terminating end.

8. The tire inflation safety cage assembly according to claim 7, wherein the tire inflation safety cage assembly is configured such that the tire inflation safety cage system includes an air blast bead seater device which is operatively coupled with the at least one valve and is configured for fluidly communicating with the at least one hollow tube, wherein the at least one valve is configured for transmitting the pressurized air from the air conveyor device into the at least one hollow tube.

9. The tire inflation safety cage assembly according to claim 8, wherein the tire inflation safety cage assembly is configured such that the air blast bead seater device is configured for emitting a blast of the pressurized air from the at least one hollow tube towards the wheel assembly so as to seat a tire of the wheel assembly onto a wheel of the wheel assembly.

10. The tire inflation safety cage assembly according to claim 9, wherein the at least one valve includes an actuator configured for enabling the pressurized air to flow therethrough.

11. The tire inflation safety cage assembly according to claim 10, wherein the tire inflation safety cage assembly is configured such that the tire inflation safety cage system includes at least one air conduit configured for transmitting the pressurized air from the air conveyor device to the at least one hollow tube or from the at least one hollow tube to the air blast bead seater device.

12. The tire inflation safety cage assembly according to claim 11, wherein the air blast bead seater device has an absence of an air storage tank, and wherein the at least one valve is fluidly coupled with the at least one hollow tube.

13. A method of using a tire inflation safety cage system, the method comprising the steps of:
providing that the tire inflation safety cage system includes an air conveyor device and a tire inflation safety cage assembly, the tire inflation safety cage assembly including a frame and at least one valve, the frame including at least one hollow tube, the at least one valve being coupled with the frame;
selectively operatively coupling the tire inflation safety cage assembly with the air conveyor device;
storing pressurized air in the at least one hollow tube;
surrounding, by way of the at least one hollow tube, at least partly a wheel assembly; and
transmitting, by way of the at least one valve, the pressurized air out of the at least one hollow tube.

14. The method according to claim 13, wherein the tire inflation safety cage system further includes an air blast bead seater device operatively coupled with the at least one valve and configured for fluidly communicating with the at least one hollow tube.

15. The method according to claim 14, wherein the air blast bead seater device is configured for emitting a blast of the pressurized air from the at least one hollow tube towards the wheel assembly so as to seat a tire of the wheel assembly onto a wheel of the wheel assembly.

16. The method according to claim 15, wherein the at least one valve includes an actuator configured for enabling the pressurized air to flow therethrough.

17. The method according to claim 16, wherein the tire inflation safety cage system further includes at least one air conduit configured for transmitting the pressurized air from the air conveyor device to the at least one hollow tube or from the at least one hollow tube to the air blast bead seater device.

18. The method according to claim 17, wherein the air blast bead seater device has an absence of an air storage tank, and wherein the at least one valve is fluidly coupled with the at least one hollow tube.

19. The tire inflation safety cage system according to claim 6, wherein the frame includes at least one hollow joining tube in fluid communication with the at least one hollow tube, and the at least one valve is fluidly coupled with the at least one hollow joining tube and the at least one hollow tube.

20. The tire inflation safety cage system according to claim 19, wherein at least one of:
(i) each of the at least one valve is directly coupled with a corresponding said at least one hollow tube or a corresponding said at least one hollow joining tube; and
(ii) the frame includes a plurality of the at least one hollow tube, and the at least one hollow joining tube comprises a single joining tube which fluidly interconnects each said hollow tube.
